(19) United States
(12) Patent Application Publication
(10) Pub. No.: US 2016/0230675 A1
(43) Pub. Date: Aug. 11, 2016

(54) FAN FLOW CONTROL VALVE

(71) Applicant: United Technologies Corporation, Hartford, CT (US)

(72) Inventors: Jeffery A. Lovett, Tolland, CT (US); Dennis J. Nemecek, Port St. Lucie, FL (US)

(21) Appl. No.: 14/617,615

(22) Filed: Feb. 9, 2015

(51) Int. Cl. F02C 9/16; F02C 3/04

(52) U.S. Cl. CPC F02C 9/16; F02C 3/04

(57) ABSTRACT

Aspects of the disclosure are directed to an engine of an aircraft. A first duct may be configured to convey a first flow, a second duct may be configured to convey a second flow that corresponds to a first portion of the first flow, and a third duct may be configured to convey a third flow that corresponds to a second portion of the first flow. At least one valve may be configured to control a cross-sectional area associated with at least one of the second duct or the third duct in order to control the ratio of the first portion to the second portion.

### BACKGROUND

In modern aircraft environments, turbine exhaust case (TEC) modules are typically air cooled using fan bypass air in a gas turbine engine. Future engines may include, or be associated with, variable and adaptive cycles where the major air streams are varied as a function of operating conditions to maximize/optimize performance and operability. There is a need to vary the flow into the TEC in these engines to provide high levels of air flow for conditions where high cooling is needed, but also provide reduced flow for other conditions since the air supplied to the TEC takes the form of a loss with respect to the engine cycle.

A valve may be used to support varying the air streams. Most valves rely on an introduction of a small control area with an abrupt area change which creates a parasitic pressure drop to reduce flow, which means losses are high in this mode. Valve methods which provide a smooth aerodynamic flow path to provide a very low pressure drop, the subject here, would benefit the engine cycle.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a system associated with an engine of an aircraft, comprising: a first duct configured to convey a first flow, a second duct configured to convey a second flow that corresponds to a first portion of the first flow, a third duct configured to convey a third flow that corresponds to a second portion of the first flow, and at least one valve configured to control a cross-sectional area associated with at least one of the second duct or the third duct in order to control the ratio of the first portion to the second portion. In some embodiments, the first flow is a fan flow, the second flow is a nozzle flow, and the third flow is a turbine exhaust case flow. In some embodiments, at least a portion of the second flow is used to cool a component associated with a nozzle of the aircraft. In some embodiments, at least a portion of the second flow is exhausted in order to provide forward thrust for the aircraft. In some embodiments, the at least one valve comprises an actuator and a piston. In some embodiments, the valve is coupled to an engine control system, and a state of the valve is controlled based on a command received by the valve from the engine control system. In some embodiments, the at least one valve is located within a fan duct. In some embodiments, the at least one valve is located outside of a fan duct. In some embodiments, the system is configured to provide the third flow through a plurality of turbine exhaust case vanes. In some embodiments, the system is configured to divert the third flow downstream of turbine exhaust case vanes to provide a flow going into a core.

Aspects of the disclosure are directed to a system associated with an engine of an aircraft, comprising: a first duct configured to convey a fan bypass flow, a second duct configured to convey a first portion of the fan bypass flow as at least one of a cooling nozzle flow or a thrust flow, a third duct configured to convey a second portion of the fan bypass flow as a turbine exhaust case flow, and at least one valve configured to adaptively control a cross-sectional area associated with at least one of the second duct or the third duct based on a command received by the at least one valve. In some embodiments, the third duct is configured to convey the turbine exhaust case flow to at least one strut associated with a bearing at an output of a turbine. In some embodiments, the at least one valve is located within a fan duct. In some embodiments, the at least one valve is located outside of a fan duct.

### BRIEF DESCRIPTION OF THE DRAWINGS

The present disclosure is illustrated by way of example and not limited in the accompanying figures in which like reference numerals indicate similar elements.

FIG. 1 illustrates a gas turbine engine.

FIG. 2A illustrates a system for modulating a fan flow in terms of a turbine exhaust case (TEC) flow and a nozzle flow.

FIG. 2B illustrates a cross-section of a channel associated with the TEC flow of FIG. 2A.

FIG. 3A illustrates a system for modulating a fan flow in terms of a TEC flow and a nozzle flow.

FIG. 3B illustrates a cross-section of a channel associated with the TEC flow of FIG. 3A.

FIGS. 4A-4C illustrate a system for diverting a fan flow downstream of TEC vanes to control a flow going into a core.

### DETAILED DESCRIPTION

It is noted that various connections are set forth between elements in the following description and in the drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities.

In accordance with various aspects of the disclosure, apparatuses, systems and methods are described for varying a flow to a turbine exhaust case (TEC) 29. The variation may be obtained without causing a large pressure loss (e.g., a loss in an amount greater than a threshold).

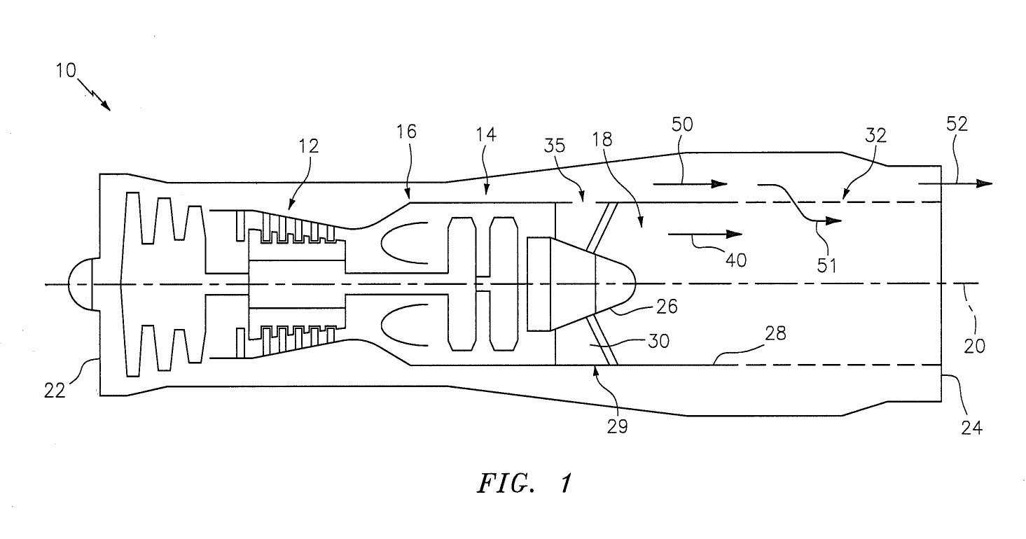

Aspects of the disclosure may be applied in connection with a gas turbine engine. For example, FIG. 1 is a side-sectional illustration of a gas turbine engine 10. The engine 10 includes a compressor section 12, a turbine section 14 and one or more engine hot sections. The engine hot sections may include, for example, a first engine hot section 16 configured as a combustor section and a second engine hot section 18 configured as an augmentor section. The compressor section 12, the first engine hot section 16, the turbine section 14 and the second engine hot section 18 may be sequentially aligned along an axial centerline 20 between a forward engine airflow inlet 22 and an aft engine airflow exhaust 24. The second engine hot section 18 involving secondary combustion to augment the engine thrust may include a first (e.g., annular, radial inner) duct case 26, a second (e.g., annular, radial outer) duct case 28, and one or more hot section vanes 30 to connect and support the ducts 26 and 28 as well as support the rotor shaft of the engine using a bearing.

One skilled in the art would appreciate that, in connection with the design and operation of an engine (e.g., engine 10), there may exist at least two flows. A first such flow, which may be referred to as a core flow 40, may pass through the engine hardware and be subjected to combustion in, e.g., the first engine hot section 16. A secondary flow, which may be referred to as a bypass flow 50, bypasses the engine core. A bypass ratio may be established for denoting the ratio between the bypass flow 50 and the core flow 40. The bypass ratio may be one measure of the efficiency (e.g., the fuel efficiency) of the engine 10. The bypass flow 50 typically provides cooling air 51 passing through the hot surfaces 32 of the exhaust nozzle and/or flows out of the exhaust 52 to add thrust.

FIG. 1 represents one possible configuration for an engine 10. Aspects of the disclosure may be applied in connection with other engine configurations.

TEC modules 29 associated with, e.g., the turbine 14, such as for example struts associated with bearings at the output of the turbine 14, may be cooled using air from a given flow (e.g., the bypass flow 50) passing through openings 35 in the TEC vanes 30. In some embodiments, a moving flowpath boundary may be provided to streamline a capture of a feed of air flow to the TEC, thereby changing the flow into the TEC without creating large parasitic pressure losses.

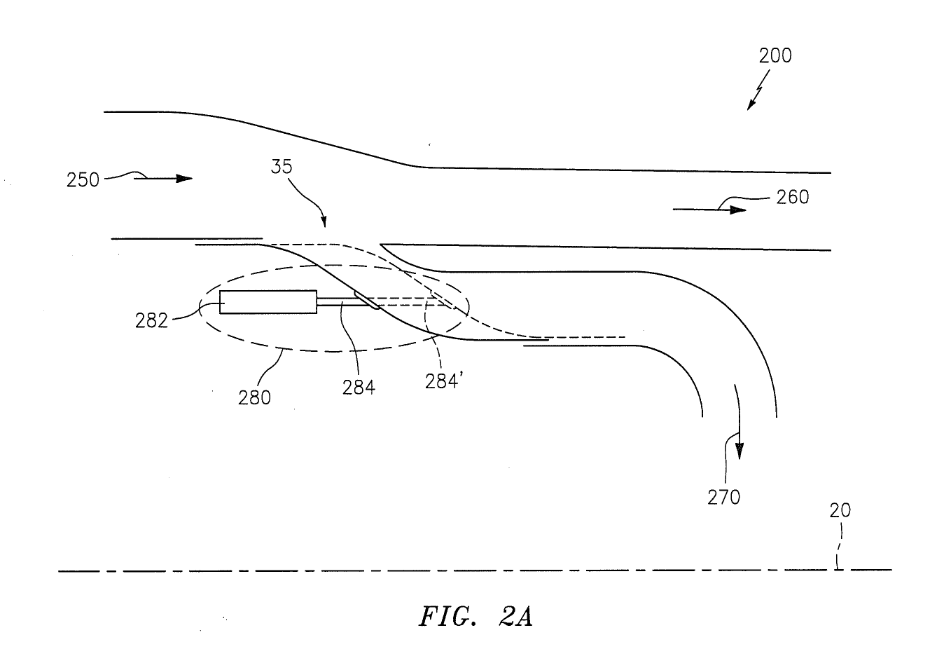

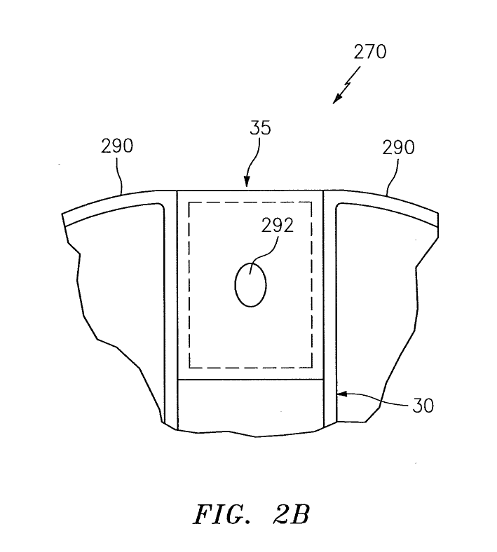

Referring to FIG. 2A, an exemplary system 200 for obtaining such a moving flowpath boundary is shown. The system 200 includes a flow 250, which may correspond to at least a portion or the entirety of the bypass flow 50 described above in connection with FIG. 1. The flow 250 may be referred to as a fan flow.

The flow 250 may effectively be split into two flows. A first of these two flows is denoted in FIG. 2A via reference character 260. The flow 260 may be referred to as a nozzle flow. At least a portion of the flow 260 may be used to cool components associated with a nozzle 51 of an aircraft. Alternatively, or additionally, at least a portion of the flow 260 may be dumped/exhausted 52 in order to provide (forward) thrust for the aircraft. In this respect, the flow 260 may be referred to as a thrust flow.

A second of these two flows is denoted in FIG. 2A via reference character 270. The flow 270 may be associated with the TEC modules described above, and as such, may be referred to as a TEC flow passing though openings 35 into the TEC vanes 30.

The ratio of (the splitting of the flow 250 into) the flow 260 to the flow 270 may be controlled based on a valve 280. The valve 280 is shown in FIG. 2A as being located within a duct associated with the fan. The valve 280 may include a piston/rod 284 that is driven by an actuator 282. The valve 280/rod 284 is shown as being in a first, open position in FIG. 2A, thereby providing for a large area, and hence, flow 270.

Also superimposed in FIG. 2A for reference purposes is the rod 284 in a second position, as indicated by the reference character 284′. When the valve 280/rod 284 is in this second position 284′, the valve 280 is closed and a larger portion of the flow 250 is directed/provided to the flow 260 (relative to the flow 270).

The actuator 282 may be driven by, or respond to commands from, an engine control system (not shown). The engine control system may include logic to determine a state/position for the valve 280, and hence, the actuator 282.

Regardless of the state/position of the valve 280, the channels/ducts associated with the flows 260 and 270 may include relatively smooth, aerodynamic surfaces. Accordingly, loss (e.g., a pressure drop) that is associated with the flow 260 or the flow 270 may be small/minimal.

Referring to FIG. 2B, a cross-section associated with the flow 270 of the system 200 is shown. In particular, a TEC module 290 (e.g., a strut) is shown as proximate to a valve moving body 292, wherein the body 292 may correspond to the valve 280 of the system 200 opening of closing the opening 35 into the TEC vane 30.

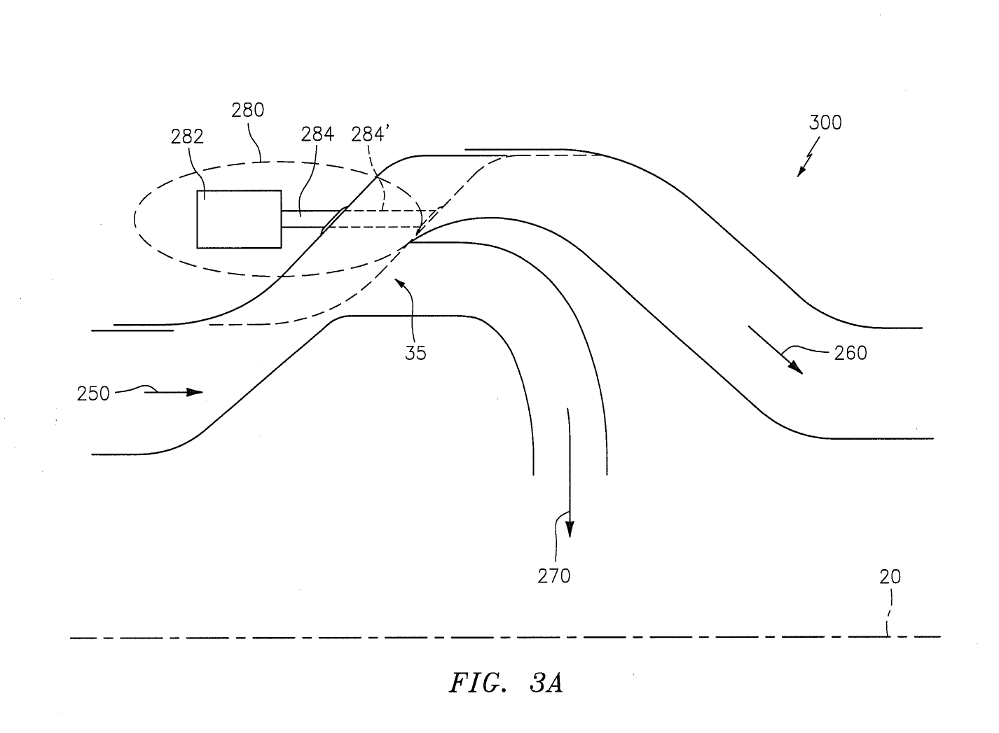

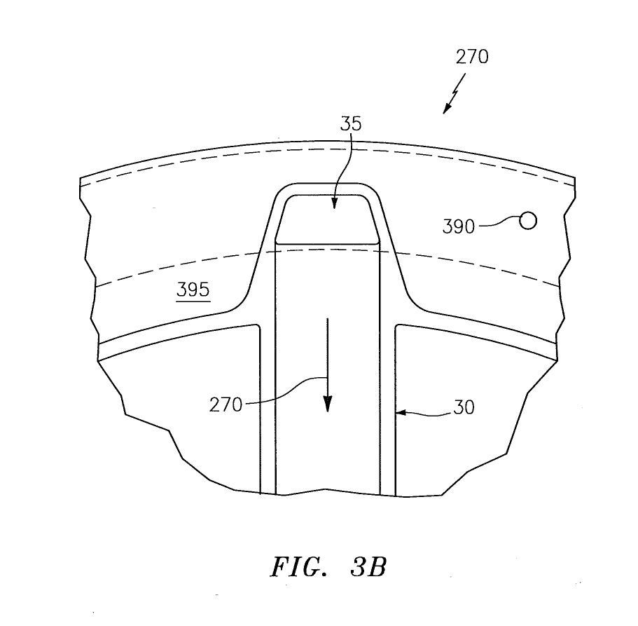

Referring to FIG. 3A, an exemplary system 300 for obtaining a moving flowpath boundary is shown. The system 300 includes many of the flows and components/devices, and many of the same characteristics, as described above in connection with the system 200 of FIG. 2A, and so, a complete re-description is omitted for the sake of brevity. In contrast to the system 200, in the system 300 the valve 280 is shown as being located outside of the fan duct. All other things being equal, the valve 280 may operate at cooler temperatures in the system 300 relative to the system 200. Easier access to the valve 280 for, e.g., maintenance or inspection activities may be obtained using the system 300 relative to the system 200. In this case the opening 35 to the vane 30 is raised above the fan duct flow path 250 to enable closing of the valve with a horizontal translating valve 200.

Referring to FIG. 3B, a cross-section associated with the flow 270 of the system 300 is shown. A translating ring 390 is included in proximity to the vane opening 35 wherein flow 270 into the vane 30 is controlled. Flow to the nozzle 260 is allowed to pass around the valve through passage 395.

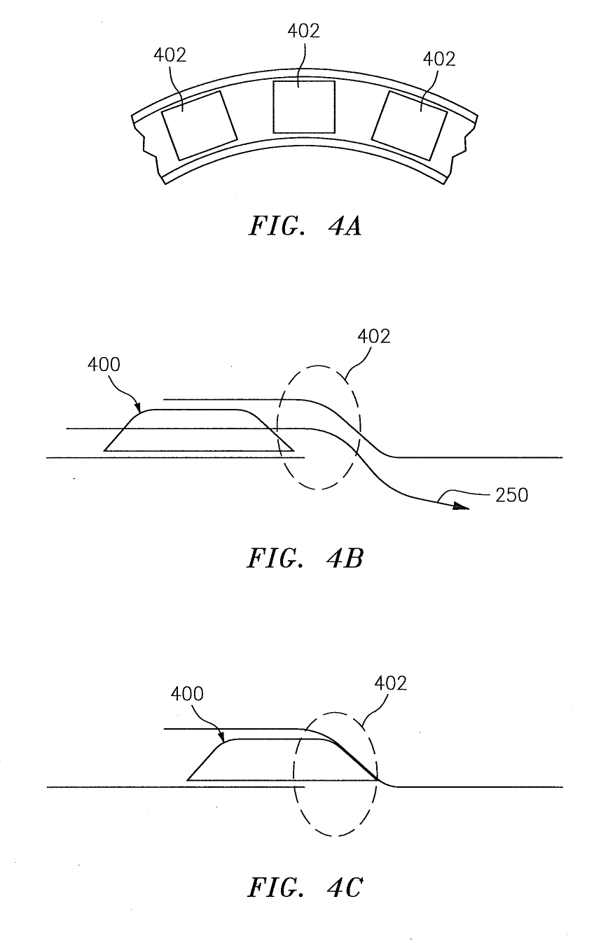

In conjunction with the systems and flows described above in connection with FIGS. 2A-2B and 3A-3B, the modulation/metering of the flows 250-270 may be performed to control flow through one or more TEC vanes 30. In contrast thereto, the embodiment of FIGS. 4A-4C may be used to divert flow downstream of the TEC vanes, to control/provide a flow combining with the core 40. The flow can combine with the core 40 in close proximity to the TEC to participate in combustion of the augmentor 18, or combine farther downstream as with the cooling flow 51 thereby changing the engine cycle bypass ratio.

As shown in FIG. 4A, one or more passages 402 may be selectively provided in a translating ring 400 to accommodate the flow 250. In FIG. 4B, one of the passages 402 is shown in an open state/position, allowing for traversal of the flow 250 therethrough. In contrast to FIG. 4B, in FIG. 4C the passage 402 is substantially closed, such that the flow 250 is generally precluded from flowing through the passage 402.

In view of the foregoing, aspects of the disclosure may be used to modulate one or more flows by controlling (e.g., modifying) a cross-section/area of one or more channels/ducts associated with the flows that are always aerodynamically smooth to reduce parasitic pressure losses. A valve may be used to provide such control. By utilizing arrangements such as those described herein, aerodynamic efficiency may be enhanced/increased.

Technical effects and benefits of this disclosure include providing a variable flow into a TEC 29 or the core 40. Such a flow may be provided with minimal, parasitic pressure losses, thereby maintaining engine performance/efficiency. Aspects of the disclosure may be applied in connection with so-called adaptive engines to facilitate a dynamic alteration of one or more engine parameters. For example, if maximum thrust is desirable then a TEC flow may be reduced, whereas if it desirable to increase cooling to the TEC then the TEC flow may be increased.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure.

What is claimed is:

1. A system associated with an engine of an aircraft, comprising:
a first duct configured to convey a first flow;
a second duct configured to convey a second flow that corresponds to a first portion of the first flow;
a third duct configured to convey a third flow that corresponds to a second portion of the first flow; and
at least one valve configured to control a cross-sectional area associated with at least one of the second duct or the third duct in order to control the ratio of the first portion to the second portion.

2. The system of claim 1, wherein the first flow is a fan flow, the second flow is a nozzle flow, and the third flow is a turbine exhaust case flow.

3. The system of claim 1, wherein at least a portion of the second flow is used to cool a component associated with a nozzle of the aircraft.

4. The system of claim 1, wherein at least a portion of the second flow is exhausted in order to provide forward thrust for the aircraft.

5. The system of claim 1, wherein the at least one valve comprises an actuator and a piston.

6. The system of claim 1, wherein the valve is coupled to an engine control system, and wherein a state of the valve is controlled based on a command received by the valve from the engine control system.

7. The system of claim 1, wherein the at least one valve is located within a fan duct.

8. The system of claim 1, wherein the at least one valve is located outside of a fan duct.

9. The system of claim 1, wherein the system is configured to provide the third flow through a plurality of turbine exhaust case vanes.

10. The system of claim 1, wherein the system is configured to divert the third flow downstream of turbine exhaust case vanes to provide a flow going into a core.

11. A system associated with an engine of an aircraft, comprising:
a first duct configured to convey a fan bypass flow;
a second duct configured to convey a first portion of the fan bypass flow as at least one of a cooling nozzle flow or a thrust flow;
a third duct configured to convey a second portion of the fan bypass flow as a turbine exhaust case flow; and
at least one valve configured to adaptively control a cross-sectional area associated with at least one of the second duct or the third duct based on a command received by the at least one valve.

12. The system of claim 11, wherein the third duct is configured to convey the turbine exhaust case flow to at least one strut associated with a bearing at an output of a turbine.

13. The system of claim 11, wherein the at least one valve is located within a fan duct.

14. The system of claim 11, wherein the at least one valve is located outside of a fan duct.
